(19) United States
(12) Patent Application Publication
(10) Pub. No.: US 2017/0361590 A1
(43) Pub. Date: Dec. 21, 2017

(54) PACKAGING MATERIAL FOR PREVENTION OF RUSTING AND METHOD OF MANUFACTURING THE SAME

(71) Applicants: George S. Helms, Canton, MI (US); Kevin Heires, Midland, MI (US)

(72) Inventors: George S. Helms, Canton, MI (US); Kevin Heires, Midland, MI (US)

(21) Appl. No.: 15/438,756

(22) Filed: Feb. 22, 2017

Related U.S. Application Data
(63) Continuation of application No. 15/183,774, filed on Jun. 15, 2016, now abandoned.

(51) Int. Cl. B32B 27/20; B32B 27/08; B65D 65/42; B32B 27/36; B65D 81/02

(52) U.S. Cl. CPC B32B 27/20; B32B 27/36; B65D 81/02; B65D 65/42; B32B 27/08; B32B 2250/03; B32B 2250/244; B32B 2553/00; B32B 2307/752

(57) ABSTRACT

A packaging material (material) of the present invention is used to cover and wrap the metal parts during transportation and storing and in order to prevent rusting and corrosion. The material includes an inner layer and a pair of outer layers sandwiching the inner layer. The inner layer is formed from extruded rigid PET material wherein the outer layers are fabricated from VCI (vapor corrosion inhibitor) embedded into extruded sheets of rigid PET. The material is used for packaging for all ferrous metals for anti-rust. As VCI is thermoformed to embed corrosion inhibitors directly into rigid plastic material of the outer layers it improves quality by ensuring corrosion inhibitors are incorporated into all packaging.

### FIELD OF INVENTION

This invention relates to packaging materials for metallic part to prevent rusting, more particularly, to novel corrosion inhibitors, method and techniques of utilization thereof.

### BACKGROUND OF THE INVENTION

Packaging materials of all kinds have been used for years in order to package metals parts of all kinds when transporting the same between different locations or simply storing the parts. The packaging materials are used in numerous industries including and not limited to automotive industry, aerospace industry, and many others as almost every industry uses parts and components manufactured from metals of all kinds.

Most packaging materials are fabricated from plastics. Essentially the material “gasses” out of the plastic material. The molecules coat metal surfaces with a molecule thick layer. When an electrolyte is near the surface of the metal, the electrons flow from higher energy to lower energy areas of the metal and loop the transfer of electrons through the electrolyte. This process causes the formation of oxidation build up on the surface of the metal, and thus causes “rust”. It is important to keep created a molecule thick layer around the metal in order to stop escaping of the current flow of electrons.

In the past, various corrosion inhibitor products have been widely used in a number of applications, ranging from engine use to product packaging. One common form of corrosion inhibitor products is the use of vapor-phase inhibitor emitting compounds in product packaging, including compounds being incorporated into plastic packaging film, and small containers of vapor-phase corrosion inhibitor material that are placed into a shipping or packaging container for a product that may otherwise be susceptible to corrosion of the metal parts. Plastic film with corrosion inhibitor compounds is made by incorporating such compounds into low density polyethylene resin, which is extruded and formed into plastic sheet stock that is used as a wrap or as envelopes of plastic packaging for the metal being protected from corrosion.

Other similar products and methods include the use of a coating on a portion of the packaging material, use of tablets of the corrosion inhibitor compound, use of an absorbent pad treated with corrosion inhibitor compounds and taped to the inside of a shipping container, use of cups containing the compound with a vapor permeable top cover, and use of vapor-permeable envelopes containing powdered solid of the corrosion inhibitor compound.

Alluding to above, U.S. Pat. No. 5,426,916 to Grigsby, for example, teaches a liquid-impregnated flexible sheet includes high capillarity pores for retaining the impregnated fluid. The fluid may be an oil having a boiling point and vapor pressure sufficient to promote vaporization of the oil at room temperature. The vaporizable oil can function as a corrosion inhibitor making the sheet useful for wrapping metallic articles. A surfactant may also be added to the sheet to enhance corrosion inhibition. The sheet comprises a homogenous mixture of a polyolefin-based component and an inert filler. The sheet may be used alone or as one component of a composite that includes materials that have other desirable properties. The composite may be assembled into a container, such as a gun case. A vapor-phase corrosion inhibitor is a material, preferably solid at room temperature, the gaseous form of which will inhibit corrosion, particularly oxidative corrosion, of metals, especially these metals normally corroded or oxidized by the presence of water vapor in air. The problems involved in atmospheric corrosion of metals, especially ferruginous metals, by atmospheres containing water vapor and oxygen, e. g., moist or humid air, are well known to manufacturers, handlers, and users of such metals. Prior to the discovery of vapor-phase corrosion inhibitors, the only methods for combating such corrosion were either to separate the metals from the corrosive atmosphere with a coating, such as a paint, oil, or grease, or to extract one or more of the corrosive elements from the atmosphere, such as by the use of a dehydrating agent to dry the air. These methods are, in general, either too time-consuming or too ineffective to be completely satisfactory. However, under proper circumstances, as described more fully below, the use of vapor-phase corrosion inhibitors provides a simple and very satisfactory solution to the problems of corrosion.

It is, therefore, an object of this invention to provide novel and effective vapor-phase corrosion inhibitors and compositions.

It is another object of the present invention to provide new methods utilizing, and combinations including, such inhibitors and compositions.

There is a longstanding need and opportunity for improved designs and methods for fabricating new packaging materials adaptable to created a molecule thick layer around the metal parts, thereby stopping the current flow of electrons in order to prevent rusting of the metal parts.

### SUMMARY OF THE INVENTION

A packaging material of the present invention includes at least three layers, such as an inner or middle layer, and a pair of outer layers. Each of the layers are formed from impregnated base plastic (PET). Other materials such as HIPS, PE, HDPE, PP may be used without limiting the scope of the present invention. The outer layers include particles of vapor corrosion inhibitor (VCI). In one embodiment of the present invention, the particles of VCI are mixed with particles of the impregnated base plastic (PET) before the layers are extruded before the material is formed. In alternative embodiment of the present invention, there are at least three layers, such as an inner or middle layer, and a pair of outer layers. Each of the layers are formed from impregnated base plastic (PET).

Other materials such as HIPS, PE, HDPE, PP may be used without limiting the scope of the present invention. The outer layers include layers of vapor corrosion inhibitor (VCI). Each layer presents a plastic film or paper sheet. Still another alternative embodiment includes at least three layers, such as an inner or middle layer, and a pair of outer layers. Each of the layers are formed from impregnated base plastic (PET). Other materials such as HIPS, PE, HDPE, PP may be used without limiting the scope of the present invention. Each outer layer includes layer vapor corrosion inhibitor (VCI).

The layers of vapor corrosion inhibitor (VCI) are formed inside each outer layer. The thickness for the layers as structured is as follows: the outer layers include at least 2% of VCI by weight and the inner layer includes at least 100% of PET. As the material surrounds metal parts, the particles of the VCI semi-evaporate from the material and add a semi charged layer over, the metal components by about 1 to 2 molecules thick to create a evenly distributed coating, that protects against moisture and or the reaction of ferrous materials to liquids, i.e. water.

As VCI is thermoformed to embed corrosion inhibitors directly into rigid plastic material of the outer layers it improves quality by ensuring corrosion inhibitors are incorporated into all packaging.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a partial cross sectional view of a packaging material of the present invention;

FIG. 2 is a partial cross sectional view of an alternative embodiment of the packaging material of the present invention;

FIG. 3 is a partial cross sectional view of another alternative embodiment of the packaging material of the present invention;

FIG. 4 is a comparison chart that illustrates chemical reactions of metal parts in the prior at packaging environment, (as indicated at A) and chemical reaction of the metal parts sandwiched between the layers of material of present invention (as indicated at B) wherein a molecule thick layer of vapor corrosion inhibitor is created around the metal parts thereby stopping the current flow of electrons wherein current is disrupted from the acting “anode” to the “cathode” on the metal part and to prevent rusting of the metal parts;

FIG. 5 is a perspective view of several layers of packaging material covering numerous metal parts, i.e. bearings sandwiched between the layers of packaging material;

FIG. 6 is a partial cross sectional view of the metal parts sandwiched the layers that create a molecule thick layer of vapor corrosion inhibitor around the metal parts thereby stopping the current flow of electrons wherein current is disrupted from the acting “anode” to the “cathode” on the metal part and to prevent rusting of the metal parts; and

FIG. 7 illustrates a manufacturing process implemented to form the material of the present invention.

### DETAILED DESCRIPTION OF THE INVENTION

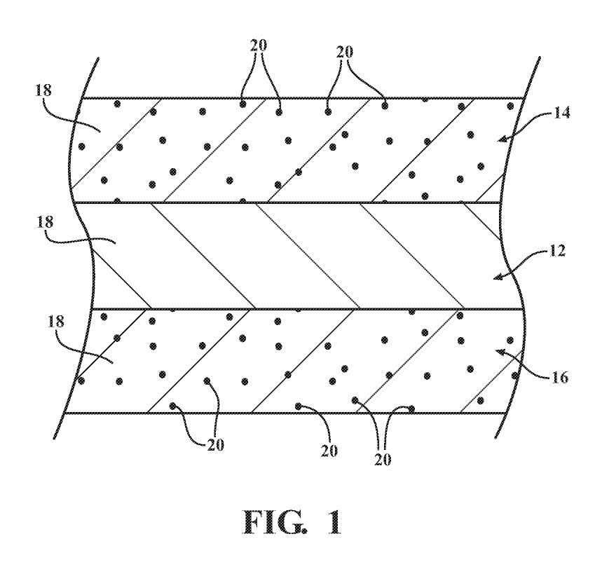

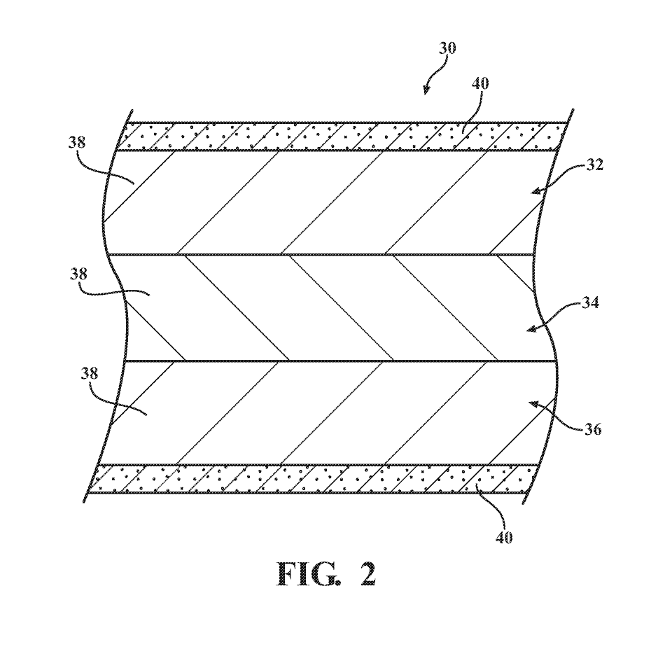

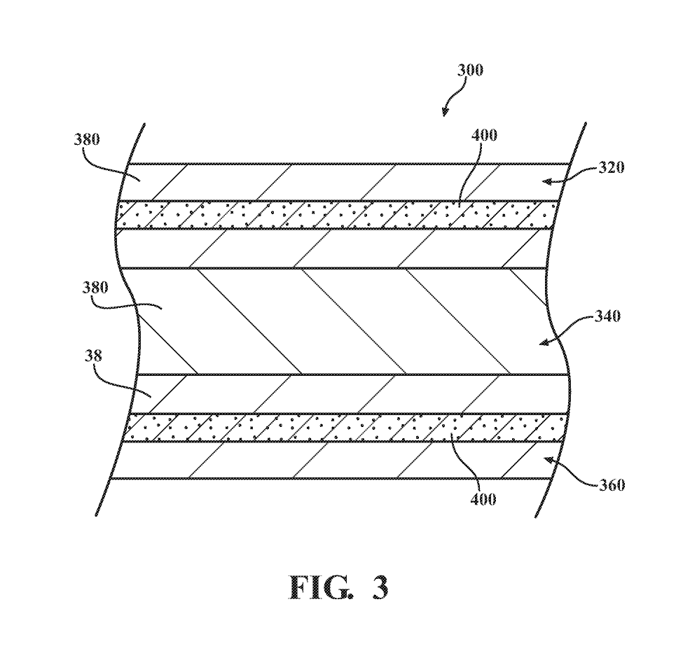

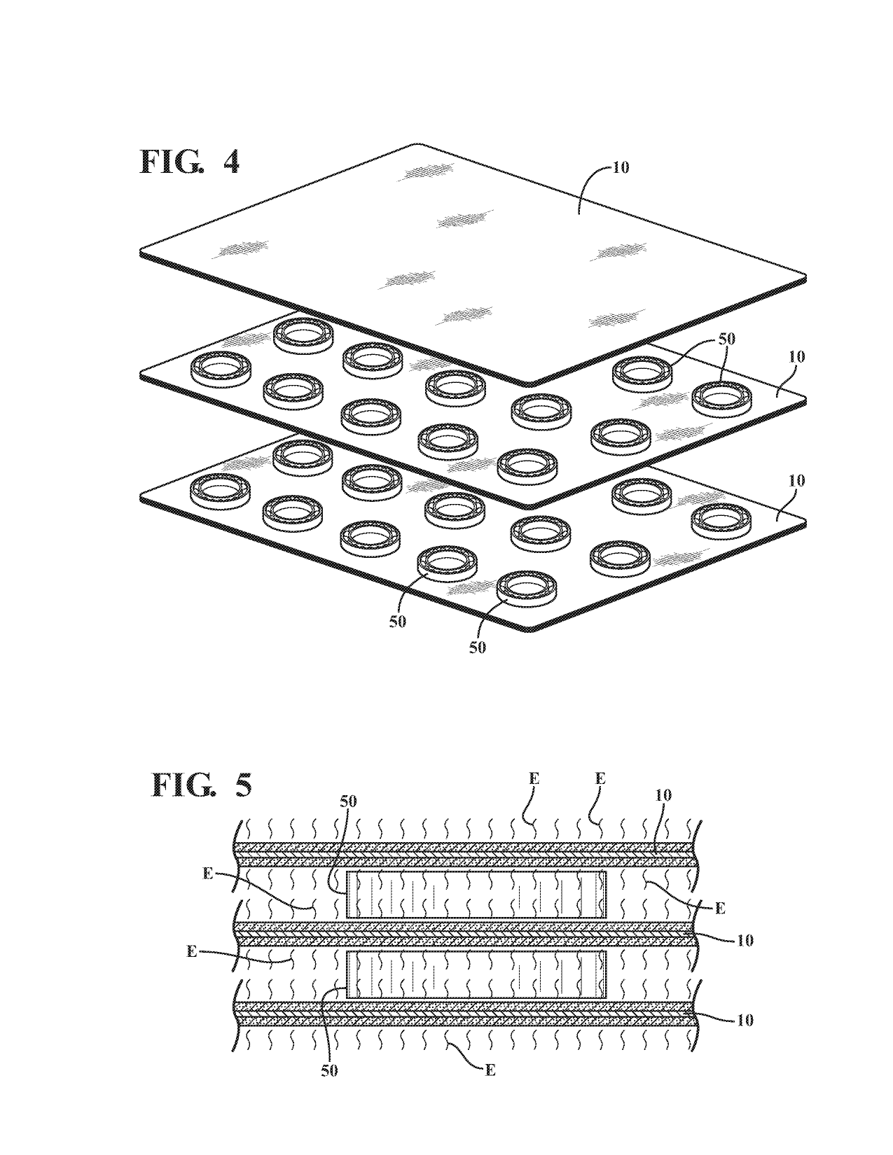

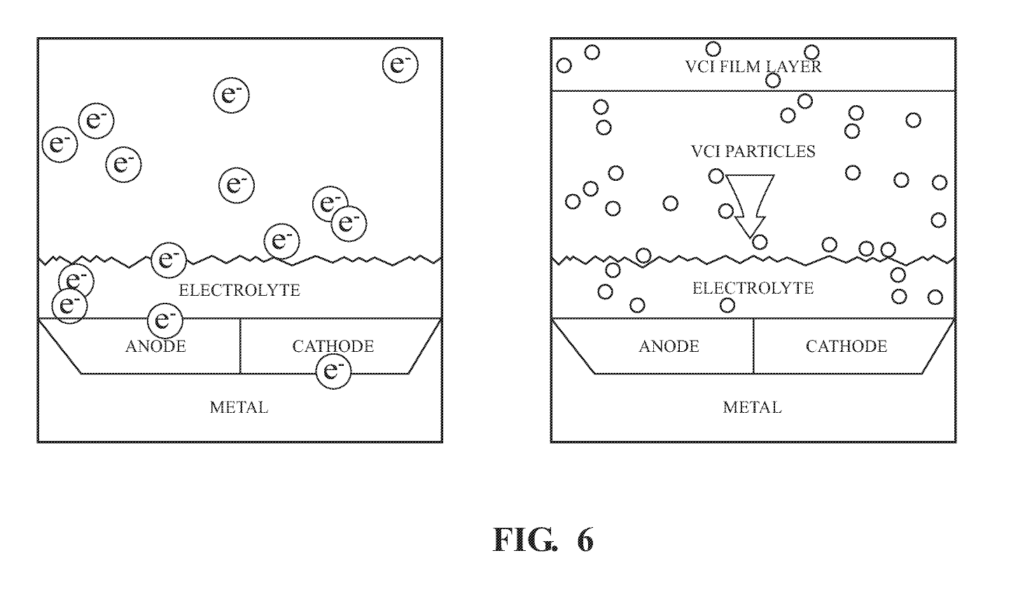

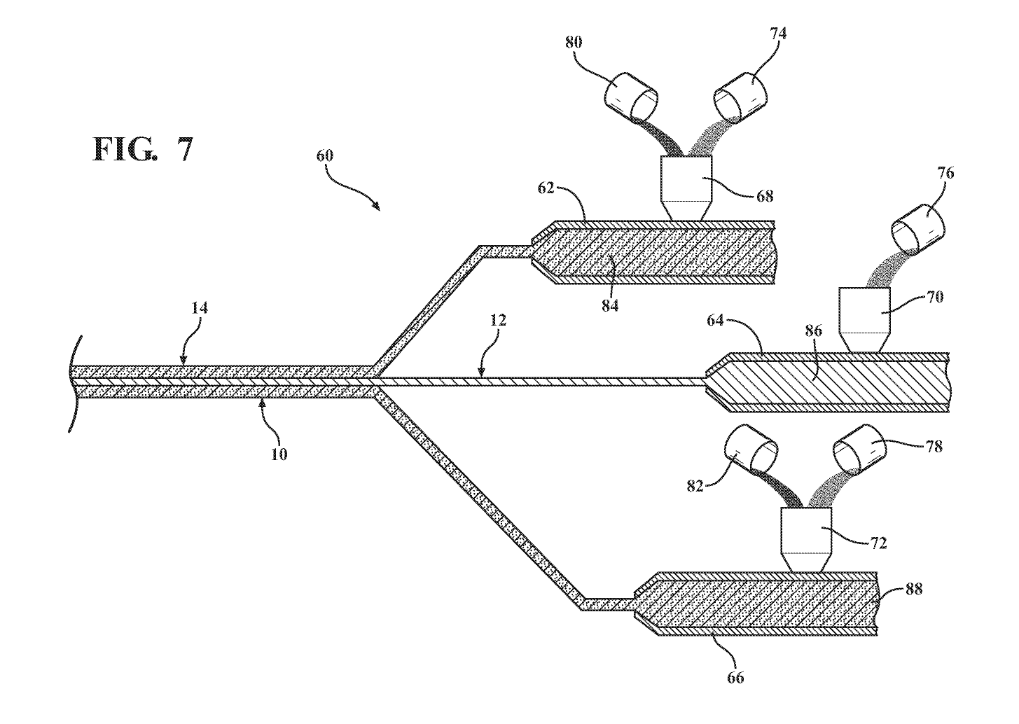

Referring to FIGS. 1-7, wherein numerals indicate like or corresponding parts, an inventive packaging material, generally shown at 10 on FIG. 1, which illustrates a partial cross sectional view of the packaging material. There are at least three layers, such as an inner or middle layer, generally indicated at 12, and a pair of outer layers, generally indicated at 14 and 16. Each of the layers 12, 14, and 16 are formed from impregnated base plastic (PET) 18. Other materials such as HIPS, PE, HDPE, PP may be used without limiting the scope of the present invention. The outer layers 14 and 16 include particles of vapor corrosion inhibitor (VCI) shown at 20. In one embodiment of the present invention, as shown on FIG. 1, the particles of VCI 20 are mixed with particles of the impregnated base plastic (PET) 18 before the layers 14 and 16 are extruded before the material 10 is formed. In alternative embodiment of the present invention, as generally shown at 30 on FIG. 2, there are at least three layers, such as an inner or middle layer, generally indicated at 32, and a pair of outer layers, generally indicated at 34 and 36. Each of the layers 32, 34, and 36 are formed from impregnated base plastic (PET) 38. Other materials such as HIPS, PE, HDPE, PP may be used without limiting the scope of the present invention. The outer layers 34 and 36 include layers of vapor corrosion inhibitor (VCI) shown at 40. Each layer 40 presents a plastic film or paper sheet as shown on FIG. 2. Still another alternative embodiment is generally shown at 300 on FIG. 3. There are at least three layers, such as an inner or middle layer, generally indicated at 340, and a pair of outer layers, generally indicated at 320 and 360. Each of the layers 320, 340, and 360 are formed from impregnated base plastic (PET) 380. Other materials such as HIPS, PE, HDPE, PP may be used without limiting the scope of the present invention. Each outer layer 320 and 360 include layer vapor corrosion inhibitor (VCI) shown at 400. The layers of vapor corrosion inhibitor (VCI) 400 are formed inside each outer layer 320 and 360. The thickness values for the layers as shown on FIG. 1, as structured is as follows: are: the layer 14 and 16 include at least 2% of VCI by weight and the inner layer 12 includes at least 100% of PET 18. Referring to FIGS. 4-6, as the material 10 surrounds metal parts 50, the particles 20 of the VCI semi-evaporate from the material and add a semi charged layer over, as shown at E on FIG. 6, the metal components 50 by about 1 to 2 molecules thick to create a evenly distributed coating, that protects against moisture and or the reaction of ferrous materials to H20. FIG. 4 shows a comparison chart that illustrates chemical reactions of metal parts in the prior at packaging environment, (as indicated at A) and chemical reaction of the metal parts sandwiched between the layers of material of present invention (as indicated at B) wherein a molecule thick layer of vapor corrosion inhibitor is created around the metal parts thereby stopping the current flow of electrons wherein current is disrupted from the acting “anode” to the “cathode” on the metal part and to prevent rusting of the metal parts. Referring now to FIG. 7, FIG. 7 illustrates a manufacturing process implemented to form the material of the present invention Incorporate VCI (vapor corrosion inhibitor) directly into Extruded Sheets that can be thermoformed into Rigid Packaging. I believe this could be an incredible opportunity to create a niche market that is clean packaging. Packaging for all ferrous metals for anti-rust inhibitors Innovation: First thermoformed to embed corrosion inhibitors directly into rigid plastic packaging materials. Improves quality by ensuring corrosion inhibitors are incorporated into all packaging. VCI Chemical Resin is from ALL ARMOR Protective Packaging. I am not sure how we want to go about specifying the structure. As of right now it is a 3 layer structure. We were able to reduce cost by modifying the outer two layers and removing VCI from the center layer. The objective will be to offer varied quantities of VCI of 2%, 3%, 4% for various required “life” of the tray. We are honing in @ what % VCI=length of VCI protection. This percent of VCI resin will be mixed homogenously with PET on the Top and Bottom layer. The center layer will be PET. Current testing is being performed now in humidity chamber testing. A week of testing=roughly a year of real world testing. So far we look to be performing well. Our First trial data will be complete in 3-4 weeks with result reports. Additional Added features for the second round of testing (VCI, company added this functionality from an existing product they have recently developed) VCI with that is UV detectable (Can shine a pen light and see if VCI is still present in the tray) VCI will be recyclable (need to further research) Current Structure is a co-extruded PET: PET/PET Blend/PET The 2 outside PET layers can have varying amounts of VCI. We believe 2, 3, 4% (by weight) will be the varying amounts of the VCI to protect for 5 years depending on the lab testing results. Additional features of the VCI will allow the packaging to be recyclable with #1 Recycle Symbol. It will also have the ability to be UV detectable. A UV penlight will allow the Inspector to verify VCI is still present in the material. As far as we can tell the material does not affect thermoforming. It was originally anticipated additional dwell or heat would be necessary to form, but initial test runs did not indicate so. Material acts a bit more brittle and does have a slight yellow color tint from the VCI. How does VCI work in this particular case? Essentially the material “gasses” out of the impregnated base plastic (PET). The molecules coat metal surfaces with a 1 molecule thick layer. To understand the mechanisms of corrosion process on metal you need to know a little about the chemistry at play. When an electrolyte is near the surface of a metal, the electrons flow from higher energy to lower energy areas of the metal and loops the transfer of electrons through the electrolyte. This process causes the formation of oxidation build up on the surface of the metal, and thus causes “rust”. Because the VCI has created a molecule thick layer of VCI around the metal, this stops the current flow of electrons. Current is disrupted from the acting “anode” to the “cathode”, An Ox (anode for oxidation). To release the VCI from the thermoform material, the VCI must have a high enough Vapor Pressure to permeate out of the material. This material is both Vapor Phase and Contact Phase to provide protection. The thermoplastic resin (in our particular case PET, this could also be PP, PE, or any Olefin polymer) is mixed with organic monoamine and an acid which reacts and vents the VCI chemistry.

have been developing a program to incorporate VCI (vaper corrosion inhibitor) directly into Extruded Sheets that can be thermoformed into Rigid packaging. We would be first to market with such a product. We are nearly ready to provide samples for thermoforming. First thermoformed to embed corrosion inhibitors directly into rigid plastic packaging materials. Improves quality by ensuring corrosion inhibitors are incorporated into all packaging. ere is the latest VCI update. Testing report for the VCI thermoformed Samples is supposed to be sent to me today. Conversations I had yesterday with our partner companies, said the material at 2% shows the VCI is working very well. However, they want to put more VCI in to meet the target of 5 years protection. We will be doing another trial where we will plot the performance efficacy of the VCI with 3 material runs of variable numbers of VCI. Meaning we will do a trial with High, Medium, and Low VCI to understand how well VCI gasses off of the material. These materials are being sent to AEC the week of the 18^{th}, in which we will sample and send back out for testing. Testing will take another 4 weeks or so to get data results back. I believe I was told 5 days=about a year equivalency of environmental simulated testing. After this trial is conducted, Armor Protection will approve a guarantee of VCI efficacy when we can plot this performance curve. As far as the references to PET. You may want to consider broadening this to all thermoformable rigid plastic and reference HIPS, PE, HDPE, PP, PET. impregnated base plastic (PET). AEC current material advantage is in PET based on pricing. It also provides added benefit of being more rigid, and less brittle then some of the other lower cost options. PET also offers what is considered “Clean” packaging with very good trimability. Clarity was also important as it provides packers visual ability to ensure parts trays are loaded when trays are packed. We can also add tinted color to help differentiate different SKUS as another visual cue for the automotive manufactures. However this is only indicative of the specific project we are using this initial material for. This thickness should be reflected to be any varying thickness above 0.007″ to what I would consider “rigid” packaging.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A packaging material (material) of the present invention is used to cover and wrap the metal parts during transportation and storing and in order to prevent rusting and corrosion. The material includes an inner layer and a pair of outer layers sandwiching the inner layer. The inner layer is formed from extruded rigid PET material wherein the outer layers are fabricated from VCI (vapor corrosion inhibitor) embedded into extruded sheets of rigid PET. The material is used for packaging for all ferrous metals for anti-rust. As VCI is thermoformed to embed corrosion inhibitors directly into rigid plastic material of the outer layers it improves quality by ensuring corrosion inhibitors are incorporated into all packaging.
